(19) United States
(12) Patent Application Publication
(10) Pub. No.: US 2016/0372233 A1
(43) Pub. Date: Dec. 22, 2016

(54) POLYMER PROTECTIVE JACKET FOR ELECTRIC CABLE BUNDLES IN A MOTOR VEHICLE LIGHT DEVICE

(71) Applicant: Valeo Vision, Bobigny Cedex (FR)

(72) Inventors: Erwan Faoucher, Avrille (FR); Michel Hermitte, Angers (FR); Stephane Levasseur, Briollay (FR)

(21) Appl. No.: 15/181,623

(22) Filed: Jun. 14, 2016

(30) Foreign Application Priority Data
Jun. 22, 2015 (FR) 1555681

(51) Int. Cl. H01B 7/18; B60Q 1/00

(52) U.S. Cl. CPC H01B 7/1805; B60Q 1/0088

(57) ABSTRACT

A motor vehicle light device comprising at least one light module and at least one electric cable, wherein at least one longitudinal portion of the electric cable is surrounded at least partly or completely by at least one protective jacket, the protective jacket being an electrically conductive polymer jacket.

### CROSS-REFERENCE TO RELATED APPLICATIONS

This application claims priority to the French application 1555681 filed Jun. 22, 2015, which application is incorporated herein by reference and made a part hereof.

### BACKGROUND OF THE INVENTION

1. Field of the Invention

The present invention relates to a motor vehicle light device comprising at least one electric cable surrounded at least partly by an electrically conductive protective jacket of polymer material.

It applies typically, but not exclusively, to the fields of the lighting and/or light signaling devices of motor vehicles.

The bulk and the proximity of the various elements such as the low beam modules, the high beam modules or even the additional low beam modules, that make up the motor vehicle headlights make it difficult to install electric cable bundles and fix them to the electrical connectors. Furthermore, among these elements, some, like the module assemblies and the support plate, are in motion in operational configuration, which can result in poor positioning of the electric cable bundles, even a degradation thereof with friction force.

2. Description of the Related Art

The document EP-2 266 845 discloses a means for partly mechanically protecting the electric cable bundles in a housing for a motor vehicle headlight. This means consists in inserting the electric cable bundles in a channel produced in a rigid plastic material.

That said, the installation or the mounting of the electric cable bundles within this channel is not totally satisfactory because the access to the electrical connectors situated in the housing remains difficult.

Furthermore, the electric cable bundles as arranged in these channels, when subjected to an electrical power supply, exhibit the drawback of generating electromagnetic fields electromagnetically influencing the electronic elements internal and/or external to the headlight and thus affecting the operation of surrounding components inside the housing for a motor vehicle headlight.

### SUMMARY OF THE INVENTION

The aim of the present invention is to mitigate the drawbacks of the prior art techniques by proposing a motor vehicle light device comprising at least one electric cable, significantly limiting the electrical and/or electromagnetic disturbances induced by the electric cable when it is subjected to an electric power supply, while allowing for a simplified positioning and connection of the electric cable within a housing for a light device, and notably within a housing for a motor vehicle headlight.

The subject of the present invention is a motor vehicle light device comprising at least one light module and at least one electric cable, wherein at least one longitudinal portion of the electric cable is surrounded at least partly or completely by at least one protective jacket, the protective jacket being an electrically conductive polymer jacket.

By virtue of the invention, the electric cable or cables, notably of electric cable bundle type, protected by the protective jacket, can be easily manipulated and positioned in a housing for a light device, and notably in a housing for a motor vehicle headlight. Furthermore, the protective jacket advantageously makes it possible to significantly limit, even avoid, the electromagnetic pollutions, such as, in particular, the electrical pollutions, between the electric cable or cables and their environment, and vice versa.

### The Electric Cable

In the present invention, “electric cable” should be understood to mean one or more elongate electrically conductive element(s) surrounded by at least one electrically insulating layer, the electrically insulating layer being able to be directly in physical contact with the elongate electrically conductive element or elements.

The electric cable conventionally comprises a longitudinal axis.

The elongate electrically conductive element that forms the electric cable of the invention is conventionally intended to distribute electric current between different electric devices, notably to distribute the electric current to at least one motor vehicle light module. More particularly, the electric cable of the invention is intended to be connected, or is connected, to at least one motor vehicle light module.

The elongate electrically conductive element of the electric cable can typically be a metal wire or a plurality of metal wires, twisted or not, notably of copper and/or of aluminum (with zero degree of oxidation), or one of their alloys. Preferably, the elongate electrically conductive element of the electric cable is of copper (with zero degree of oxidation).

By way of example, the electric cable can comprise one or more insulated electric wires, surrounded or not by a protective sheath.

In a particular embodiment, the motor vehicle light device can comprise at least two electric cables forming a set of electric cables, at least one longitudinal portion of the set being surrounded by the protective jacket.

By way of example, this can be at least two insulated electric conductive wires, these two insulated conductive wires being surrounded by the protective jacket.

In another particular embodiment, the motor vehicle light device can comprise at least one bundle of electric cables (i.e. electric cable bundle), at least one longitudinal portion of the bundle being surrounded by the protective jacket.

Preferably, the motor vehicle light device can comprise at least two bundles of electric cables forming a set of bundles, at least one longitudinal portion of the set of bundles being surrounded by the protective jacket.

In the context of the invention, the motor vehicle light device further comprises at least one electrical connector. The electrical connector is notably intended to be able to connect the electric cable to at least one light module.

The bundle of electric cables mentioned in the description can more particularly be a set of several electric cables comprising one or more electrical connectors. More particularly, the bundle of electric cables comprises several insulated electric wires, which are notably preassem bled, provided with one or more electrical connectors.

### The Protective Jacket

In the present invention, the protective jacket is a jacket at least partly or completely surrounding at least one longitudinal portion of the electric cable or cables.

In a first embodiment, the protective jacket is a jacket at least partly, and preferably not entirely, surrounding at least one longitudinal portion of the electric cable or cables.

In other words, the protective jacket is a jacket that is longitudinally open over the portion of the electric cable or cables to be protected. More particularly, the protective jacket has a surface that is open in cross section. It can be referred to as open protective jacket.

The open protective jacket is intended to be associated with at least a part of a housing for a light device, in order to form a closed assembly inside which the electric cable or cables are positioned. The open protective jacket thus forms, with the part of the housing with which it is associated, a protective element completely surrounding in its cross section at least one longitudinal portion of the electric cable or cables.

The open protective jacket can be fixed onto the internal surface of the housing for a light device, by any securing means well known to those skilled in the art.

Preferably, the open protective jacket can be of exoskeleton type.

The term “exoskeleton” should be understood to mean an element external to (i.e. structurally independent of) the electric cable(s) of the invention. The exoskeleton makes it possible to at least partly support and mechanically protect the electric cable or cables of the invention.

The exoskeleton can have a thickness that is substantially constant around the electric cable or cables that it partly surrounds. As an example, the thickness of the exoskeleton lies between 1 mm and 3.5 mm.

The open protective jacket can further comprise at least one first opening intended to allow at least one electrical connector of the electric cable to pass.

The open protective jacket can further comprise at least one second opening intended to allow the fixing of the jacket onto the internal surface of a housing for a light device.

In a second embodiment, the protective jacket is a jacket completely surrounding at least one longitudinal portion of the electric cable or cables.

In other words, the protective jacket is a jacket that is longitudinally closed over the portion of the electric cable or cables to be protected. More particularly, the protective jacket has a surface that is closed in cross section. This can be termed closed protective jacket.

The closed protective jacket can be fixed onto the internal surface of the housing for a light device, by any securing means well known to those skilled in the art, such as, for example, by screw-fastening, gluing or snap riveting.

Preferably, the closed protective jacket can be of the cylindrical type, and can have a thickness that is substantially constant all around the electric cable or cables. As an example, the thickness of the sheath lies between 0.3 mm and 1.0 mm. The protective jacket can thus be of the protective sheath type.

Thus, the protective jacket according to the invention is clearly different from the channel of the prior art, the latter not completely surrounding the electric cables since the channel is “U” shaped and is not therefore a so-called closed surface.

In a third embodiment, the protective jacket can comprise a protective jacket according to the first embodiment and a protective jacket according to the second embodiment.

The protective jacket according to the invention, in addition to providing a mechanical protection function, advantageously makes it possible to form an electromagnetic shielding around the longitudinal zone of the electric cable or cables that it partly or completely surrounds.

This electromagnetic shield advantageously makes it possible for the components surrounding the electric cable or cables to be protected from the electromagnetic fields that can be generated by the electric cable or cables when they are passed through by an electric current. It also makes it possible, conversely, for the electric cables protected by the protective jacket to be safeguarded from the electromagnetic fields that can be generated by the surrounding electrical and/or magnetic components passed through by electric currents.

The portion of the electric cable or cables covered by the protective jacket preferably has a length that is sufficient to form an electromagnetic, notably electrical, barrier between the electric cable or cables on the one hand, and the components surrounding the electric cable or cables on the other hand, in order to avoid the damaging effects of the electromagnetic fields. Furthermore, the dimensions, and notably the length and the thickness, of the protective jacket can also be adjusted to optimize the mechanical protection of the electric cable or cables that it surrounds.

In a particular embodiment, the protective jacket of the invention extends longitudinally over all the length of the electric cable or cables to be protected.

The protective jacket further makes it possible to hold together, and continuously over the zone to be protected, several electric cables. The handling and the installation of the set of cables surrounded by the protective jacket are thereby greatly simplified. Furthermore, the fixing of the electric cable or cables surrounded by the protective jacket of the invention onto the internal surface of a housing for a light device is optimized.

In a particular embodiment, the protective jacket is a so-called flexible jacket, by contrast to the channel of the prior art which is rigid.

The flexibility imparted by the protective jacket advantageously makes it possible to simplify the positioning thereof inside a housing for a light device.

The protective jacket of the invention is more particularly an electrically conductive jacket of polymer type.

In the present invention, the expression “electrically conductive” should be understood to convey an electrical conductivity of at least

1·10⁻⁸ S/m (Siemens per meter), preferably of at least 1·10⁻⁶ S/m, and preferably of at least 1·10⁻³ S/m, and preferably of at most 1·10³ S/m (at 25° C.).

The light device of the invention can comprise one or more protective jacket(s) according to the invention. When the light device comprises at least two protective jackets according to the invention, the electrical conductivity of each jacket can be different.

The electrical conductivity of the protective jacket according to the invention can easily be determined using an apparatus making it possible to measure electrical conductivity, such as, for example, an apparatus with the reference AUTOSIGMA 3000, marketed by the company Sofranel.

The protective jacket can be obtained from a polymer composition comprising at least one polymer.

The polymer composition of the invention can comprise one or more polymer(s), the term “polymer” being able to be understood as any type of polymer well known to those skilled in the art such as homopolymer or copolymer (e.g. block copolymer, random copolymer, terpolymer, etc.).

The polymer can be of thermoplastic or elastomer type, and can be cross-linked or not, the crosslinking being produced by techniques well known to those skilled in the art, such as, for example, peroxide cross-linking, silane cross-linking, ultraviolet cross-linking.

According to a first variant, the protective jacket of the invention can be a non-cross-linked material, notably of thermoplastic or elastomer type.

According to a second variant, it can be a material that is cross-linked, by techniques well known to those skilled in the art.

Electrical properties (i.e. electrical conductivity) of the polymer protective jacket can be obtained according to different embodiments.

According to a first embodiment, the protective jacket can be obtained from a polymer composition comprising at least one electrically conductive polymer, and optionally at least one filler.

According to a first variant, the electrically conductive polymers of the invention can be composed typically of macromolecules comprising bonds w̅ displaced at least over a part or over all the length of their macromolecular chains (i.e. backbone chains).

Preferably, the displaced bonds w̅ can be of the w̅-a-w̅ type, alternating single and multiple covalent bonds. For example, the system of conjugated double bonds can be cited, such as, for example, “—C═C—C═C—”.

According to a second variant, the electrical conductivity of the electrically conductive polymers of the invention can result in having their macromolecular chains acquire positive or negative charges through the oxidation or the reduction of electron donors or acceptors, for example being able to be doping elements.

According to a third variant, the electrical conductivity of the electrically conductive polymers of the invention can result in having the charge cited above transported by ion dissolution.

By way of example in this first embodiment, the electrically conductive polymer can be chosen from the polyanilines, preferably in the form of emeraldine; the polythiophenes; the polypyrroles; the polyacetylenes; and one of their mixtures. For marketing reference, the reference Panipol from the company Panipol Ltd can be cited, comprising a polyaniline; the reference Baytron P from the company Clevios, which comprises a polythiophene and more particularly a poly(3,4-ethylenedioxythiophene)-poly(styrenesulfonate) (PEDOT:PSS); or the marketing reference Conquest from the company Sigma-Aldrich, which comprises a polypyrrole.

The optional filler can be of any filler type well known to those skilled in the art, of mineral or organic type.

The optional filler can be electrically conductive or not.

The electrically conductive filler can be chosen notably from:
carbonaceous fillers, such as, for example, carbon black, graphite, graphene, a carbon polymorph (e.g. diamond);
metal fillers, such as aluminum, magnesium, silver, gold, copper;
composite metals, such as AlSiC (aluminum matrix comprising particles of silicon carbide);
simple or complex metal oxides, such as Al₂O₃, Fe₂O₃, MgAI₂O₄, CoFe₂O₄, BaTiO₃, TiO₂;
metal nitrides or metalloids, such as, for example, boron nitride, aluminum nitride; and
one of their mixtures.

The electrically conductive polymer will be able to be introduced into the polymer composition in a quantity sufficient to render the composition electrically conductive.

According to a second embodiment, the protective jacket can be obtained from a polymer composition comprising at least one polymer and at least one electrically conductive filler.

The polymer can be any type of polymer well known to those skilled in the art, of organic type such as, for example, polyolefins, polycarbonates, polyamides; or of inorganic type such as, for example, polyorganosiloxanes.

The polymer can be a polymer that is electrically conductive or not.

More particularly, the polymer can be an olefin polymer (i.e. polyolefin), and preferably an ethylene and/or propylene polymer. An olefin polymer is conventionally a polymer obtained from at least one olefin monomer. As an example, the polymer can be chosen from an ethylene homopolymer, ethylene copolymers, and one of their mixtures.

The electrically conductive filler can be any type of filler well known to those skilled in the art, of mineral or organic type.

The electrically conductive filler can be chosen notably from:
carbonaceous fillers, such as, for example, carbon black, graphite, graphene, a carbon polymorph;
metal fillers, such as aluminum, magnesium, silver, gold, copper;
composite metals, such as AlSiC (aluminum matrix comprising particles of silicon carbide);
simple or complex metal oxides, such as Al₂O₃, Fe₂O₃, MgAI₂O₄, CoFe₂O₄, BaTiO₃, TiO₂;
metal nitrides or boron metalloids, such as, for example, boron nitride, aluminum nitride; and
one of their mixtures.

The electrically conductive filler will be able to be introduced into the polymer composition in a quantity sufficient to make the composition electrically conductive, this quantity notably being able to vary according to the type and the morphology of electrically conductive filler selected.

By way of example in this second embodiment, polymer compositions comprising at least one polymer and at least one electrically conductive filler that can be cited include the electrically conductive products from the company Cool Polymers or Celanese, such as, for example, the marketing reference CoolPoly RS1595, based on polyamide (PA 6).

According to a third embodiment, the protective jacket can be obtained from a polymer composition comprising at least one electrically conductive polymer and at least one electrically conductive filler, the electrically conductive polymer and the electrically conductive filler being as defined in the first and second embodiments.

The electrically conductive polymer and the electrically conductive filler will be able to be introduced into the polymer composition in a quantity sufficient to make the composition electrically conductive.

In a particular embodiment, the polymer composition of the invention can comprise at least 30% by volume of polymer(s), and preferably at least 50% by volume of polymer(s), relative to the total volume of the polymer composition.

It can also comprise at most 95% by volume of polymer(s), and preferably at most 80% by volume of polymer(s), relative to the total volume of the polymer composition.

The quantity in terms of volume of polymer(s) in the polymer composition represents the total quantity of all the polymers that make up the polymer composition, whether these polymers are electrically conductive or not.

Moreover, the polymer composition of the invention can comprise at least 5% by volume of filler(s), and preferably at least 20% by volume of filler(s), relative to the total volume of the polymer composition.

It can also comprise at most 70% by volume of filler(s), and preferably at most 50% by volume of filler(s), relative to the total volume of the polymer composition.

The quantity in terms of volume of filler(s) in the polymer composition, when the polymer composition comprises at least one filler, represents the total quantity of all the fillers that make up the polymer composition, whether these fillers are electrically conductive or not.

Preferably, the polymer composition of the invention comprises at least 95% by volume of polymer(s), or at least 95% by volume of polymer(s) and of filler(s), relative to the total volume of the polymer composition.

The polymer composition of the invention can typically further comprise additives in a quantity from 0.01 to 10% by volume (inclusively) relative to the total volume of the polymer composition.

The additives are well known to those skilled in the art and can be for example chosen from:
protection agents such as antioxidants;
application agents, such as plasticizers, lubricants, oils;
cross-linking agents, such as, for example, organic peroxides; and
one of their mixtures.

### Method for Manufacturing the Protective Jacket

Since the protective jacket is based on a polymer material, any type of method well known to those skilled in the art in the field of the formulation and shaping of polymers can be used.

Examples of manufacturing methods that can be cited include injection, molding, injection molding, thermoforming or extrusion.

According to the first embodiment mentioned above, the preferred manufacturing method of the invention is molding, injection molding or thermoforming, in order to be able to easily form a jacket in exoskeleton form.

According to the second embodiment mentioned above, the preferred manufacturing method of the invention is extrusion, in order to be able to easily form a jacket in the form of a layer or sheath extruded around the electric cable or cables.

When the polymer composition of the invention comprises at least one filler, the filler is preferably incorporated in the polymer in the malleable or molten state in order to obtain a homogeneous final mixture between the polymer and the filler.

When the polymer composition comprises a cross-linking agent, such as, for example, an organic peroxide, in order to obtain a so-called cross-linked protective jacket, the cross-linking agent is mixed first of all with the polymer composition at a temperature that is sufficient to render the polymer malleable or molten but lower than the decomposition temperature of the organic peroxide. Then, once the composition is shaped, it can be cross-linked at a temperature that is sufficient to trigger the decomposition of the peroxide and thus allow for the cross-linking of the polymer composition.

### The Motor Vehicle Light Device

The present invention applies preferably to the fields of motor vehicle light devices.

More particularly, the motor vehicle light device can be a lighting and/or light signaling device. By way of example, the lighting device can be a front headlight of a motor vehicle or an interior lighting device of a motor vehicle, and the light signaling device can be a rear light of a motor vehicle. More particularly, examples of light devices that can be cited include a high beam light, a low beam light, a daytime running light, a side marker light, a brake light, a direction indicator, a fog light, etc.

The motor vehicle light device can comprise at least one light module.

More particularly, the light module is capable of emitting a light beam, and can be a lighting unit comprising at least one light source. The light source can comprise one or more semiconductor photoemissive element(s).

In a particular embodiment, the light module is capable of emitting a light beam to produce all or part of a lighting and/or light signaling function for a motor vehicle.

The light module can further comprise a heat dissipator, such as a heat sink, and a printed circuit board, notably of PCB type, and/or a flexible printed circuit board, notably of FPCB type, and/or a variable geometry interconnection device, notably of MID (molded-in device) type, these types of configuration being well known to those skilled in the art.

The light module of the light device according to the invention is intended to be connected, or is connected, to at least one electric cable conforming to the invention. The connection can be made conventionally via at least one electrical connector.

The light device according to the invention can further comprise a housing for a light device, and notably for a motor vehicle headlight, with an internal surface, and at least one means for securing the protective jacket on the internal surface of the housing. The housing makes it possible to receive the electric cable surrounded by its protective jacket.

The securing means can be, for example, a cable tie, a clip or a screw.

These and other objects and advantages of the invention will be apparent from the following description, the accompanying drawings and the appended claims.

### BRIEF DESCRIPTION OF THE ACCOMPANYING DRAWINGS

Other features and advantages of the present invention will become apparent in light of the description of nonlimiting examples of light devices according to the invention, given with reference to the figures.

FIG. 1 represents an overview of a motor vehicle light device, without protective jacket;

FIG. 2 represents a schematic view of a protective jacket of exoskeleton type according to the invention;

FIG. 3 represents an overview of a motor vehicle light device according to FIG. 1 comprising the protective jacket of FIG. 2;

FIG. 4 represents a schematic view of a bundle of electric cables partly surrounded by a protective jacket of sheath type according to the invention; and

FIG. 5 represents an overview of a motor vehicle light device comprising the bundle of electric cables partly surrounded by a protective jacket of sheath type of FIG. 4.

### DETAILED DESCRIPTION OF THE PREFERRED EMBODIMENTS

For reasons of clarity, only the elements that are essential to the understanding of the invention have been represented schematically, and without respect for scale.

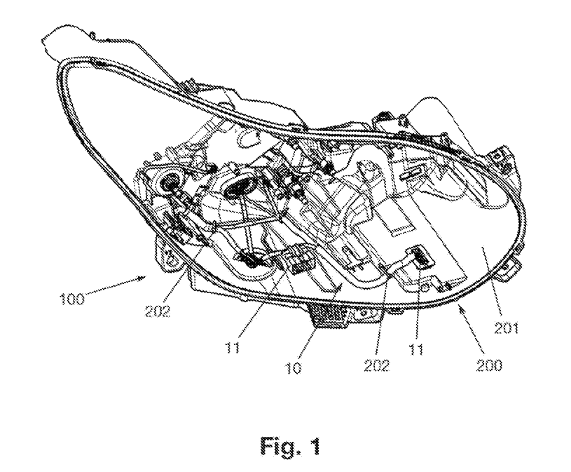

FIG. 1 represents a schematic view of a motor vehicle light device 100 not comprising any protective jacket as defined in the present invention.

The light device 100 comprises a housing 200 for a motor vehicle headlight with an internal surface 201, and a bundle 10 of electric cables positioned on the internal surface of the housing 200, the bundle 10 of electric cables comprising electrical connectors 11. At least one of these electrical connectors 11 is intended to be connected to at least one light module (not represented).

The bundle 10 of electric cables is fixed onto the internal surface 201 of the housing 200 using securing means 202.

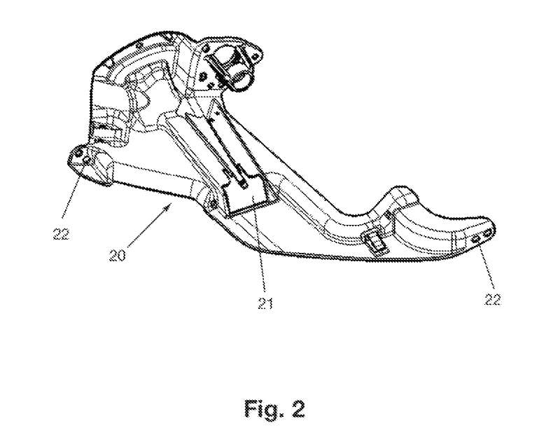

FIG. 2 represents a schematic view of a protective jacket of exoskeleton type 20 according to the invention.

This exoskeleton 20 is an electrically conductive polymer jacket according to the invention, produced by molding or injection molding. It is intended to at least partly electrically and mechanically protect the bundle 10 of electric cables positioned on the internal surface 201 of the housing, represented in FIG. 1.

The exoskeleton 20 is of non-cross-linked polymer material and is electrically conductive. It can be obtained from an electrically conductive polymer composition, marketed by the company Cool Polymers under the reference CoolPoly RS1595, based on polyamide (PA6).

The exoskeleton 20 comprises at least one first opening 21 intended to allow at least one electrical connector 11 of the bundle 10 of electric cables to pass.

It further comprises second openings 22 intended to allow the fixing of the exoskeleton 20 onto the internal surface 201 of the housing 200 for a light device, and thus form a closed jacket around the bundle 10 of electric cables.

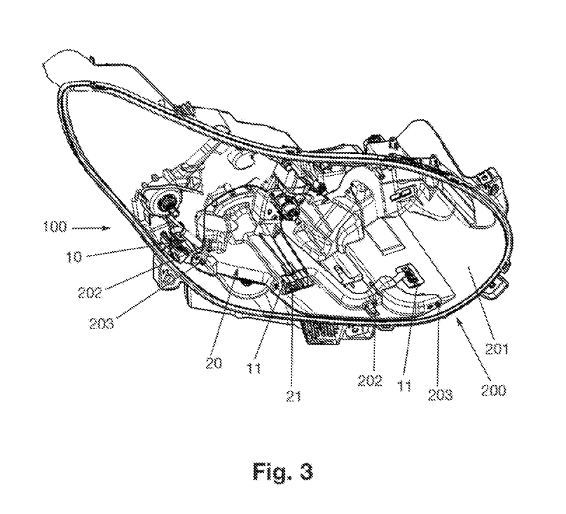

FIG. 3 represents a schematic view of the light device 100 of FIG. 1, further comprising the exoskeleton 20 of FIG. 2 fixed onto the internal surface 201 of the housing 200 for a motor vehicle headlight. Thereby the exoskeleton 20 covers at least one longitudinal portion of the bundle 10 of electric cables.

At least one of the connectors 11 is positioned in the first opening 21 and securing means 202, such as, for example, screws 203, are inserted into the second openings 22 to fix the exoskeleton 20 on the internal surface 201 of the housing 200.

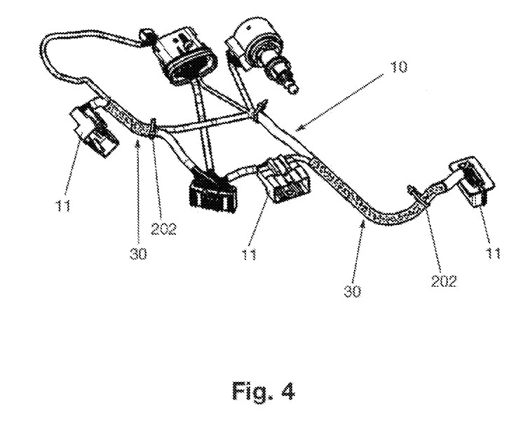

FIG. 4 represents a schematic view of a bundle 10 of electric cables comprising connectors 11, the bundle 10 of electric cables being partly surrounded by a protective jacket of sheath type 30 according to the invention.

The bundle 10 of electric cables is completely surrounded (in cross section) by the sheath 30 over two longitudinal portions of the bundle 10 of electric cables.

This sheath 30 is an electrically conductive polymer jacket according to the invention, produced by extrusion. It is intended to at least partly electrically and mechanically protect the bundle 10 of electric cables, the bundle 10 of electric cables being intended to be positioned on the internal surface 201 of the housing 200 for a motor vehicle headlight.

The sheath 30 is of non-cross-linked polymer material and is electrically conductive. It can be obtained from an electrically conductive polymer composition, marketed by the company Cool Polymers under the reference CoolPoly RS1595, based on polyamide (PA6).

The sheath 30 can be secured onto the internal surface 201 of the housing 200 for a motor vehicle headlight by securing means 202, such as, for example, of cable tie type.

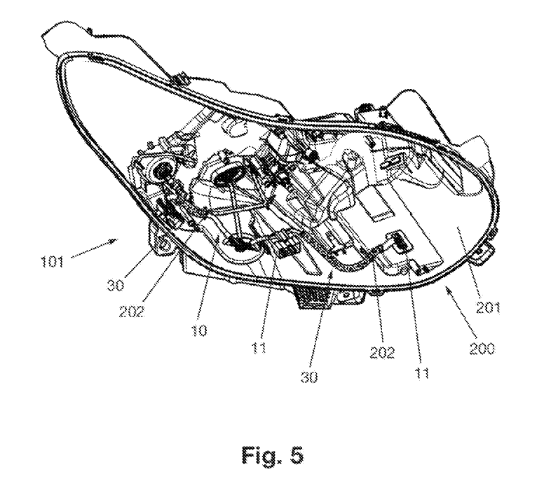

FIG. 5 represents a schematic view of a motor vehicle light device 101 comprising the bundle 10 of electric cables partly surrounded by the sheath 30, as represented in FIG. 4.

The bundle 10 of electric cables partly surrounded by the sheath 30 is fixed onto the internal surface 201 of the housing 200 for a motor vehicle headlight, using a securing means 202 of cable tie type.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A motor vehicle light device comprising at least one light module and at least one electric cable, wherein at least one longitudinal portion of said at least one surrounded at least partly by at least one protective jacket, said at least one protective jacket being an electrically conductive polymer jacket.

2. The motor vehicle light device according to claim 1, wherein at least one longitudinal portion of said at least one electric cable is surrounded completely by said at least one protective jacket.

3. The motor vehicle light device according to claim 1, wherein said motor vehicle light device comprises at least two electric cables forming a set of electric cables, at least one longitudinal portion of said set of electrical cables being surrounded by said at least one protective jacket.

4. The motor vehicle light device according to claim 1, wherein said motor vehicle light device comprises at least one bundle of electric cables, at least one longitudinal portion of said at least one bundle surrounded by said at east one protective jacket.

5. The motor vehicle light device according to claim 1, wherein said motor vehicle light device comprises at least two bundles of electric cables forming a set of bundles, at least one longitudinal portion of said set of bundles being surrounded by said at least one protective jacket.

6. The motor vehicle light device according to claim 1, wherein said at least one protective jacket is an exoskeleton.

7. The motor vehicle light device according to claim 1, wherein said at least one protective jacket is a sheath.

8. The motor vehicle light device according to claim 1, wherein the electrical conductivity of said at least one protective jacket is at least 1·10⁻⁸ S/m (Siemens per meter) (25° C.).

9. The motor vehicle light device according to one protective jacket is obtained from a polymer composition comprising at least one electrically conductive polymer, and optionally at least one filler.

10. The motor vehicle light device according to claim 9, wherein said at least one protective jacket is obtained from a polymer composition comprising at least one polymer and at least one electrically conductive filler.

11. The motor vehicle light device according to claim 9, wherein said polymer composition comprises at least 30% by volume of polymer(s) relative to a total volume of said polymer composition.

12. The motor vehicle light device according to claim 9, wherein said polymer composition comprises at least 5% by volume of filler(s) relative to a total volume of said polymer composition.

13. The motor vehicle light device according to claim 1, wherein said motor vehicle light device comprises a housing for a motor vehicle headlight with an internal surface, and at least one means for securing said at least one protective jacket on said internal surface of said housing.

14. The motor vehicle light device according to claim 2, wherein said motor vehicle light device comprises at least two electric cables forming a set of electric cables, at least one longitudinal portion of said set of electric cables being surrounded by said at least one protective jacket.

15. The motor vehicle light device according to claim 2, wherein said motor vehicle light device comprises at least one bundle of electric cables, at least one longitudinal portion of said at least one bundle of electric cables being surrounded by said at least one protective jacket.

16. The motor vehicle light device according to claim 3, wherein said motor vehicle light device comprises at least one bundle of electric cables, at least one longitudinal portion of said at least one bundle of electric cables being surrounded by said at least one protective jacket.

17. The motor vehicle light device according to claim 2, wherein said motor vehicle light device comprises at least two bundles of electric cables forming a set of bundles, at least one longitudinal portion of said set of bundles being surrounded by said at least one protective jacket.

18. The motor vehicle light device according to claim 2, wherein the electrical conductivity of said at least one protective jacket is at least 1·10⁻⁸ S/m (Siemens per meter) (25° C.).

19. The motor vehicle light device according to claim 3, wherein the electrical conductivity of said at least one protective jacket is at least 1·10⁻⁸ S/m (Siemens per meter) (25° C.).

20. The motor vehicle light device according to claim 4, wherein the electrical conductivity of said at least one protective jacket is at least 1·10⁻⁸ S/m (Siemens per meter) (25° C.).
